(19) United States
(12) Patent Application Publication
(10) Pub. No.: US 2007/0213060 A1
(43) Pub. Date: Sep. 13, 2007

(54) METHOD AND APPARATUS FOR SUPPORTING HANDOFF IN AN LTE GTP BASED WIRELESS COMMUNICATION SYSTEM

(75) Inventor: Kamel M. Shaheen, King of Prussia, PA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/683,102

(22) Filed: Mar. 7, 2007

Related U.S. Application Data
(60) Provisional application No. 60/779,739, filed on Mar. 7, 2006.
(60) Provisional application No. 60/792,935, filed on Apr. 18, 2006.

(51) Int. Cl. H04Q 7/20

(52) U.S. Cl. 455/436

(57) ABSTRACT

A single general packet radio service (GPRS) tunneling protocol (GTP) tunnel is established between an evolved Node B (ENB) and an access gateway (AGW) in a long term evolution (LTE) based wireless communication system. When ENB relocation is required, a new mobility management entity (MME)/user plane entity (UPE) sends a relocation request message to a target ENB indicating a tunnel endpoint identity (TEID) of the AGW, the identification number of a wireless transmit/receive unit (WTRU) and the packet data protocol (PDP) address of the WTRU. The new MME/UPE sends an update PDP context request message to the AGW indicating the target ENB TEID. The AGW updates a binding of the target ENB TEID with the WTRU PDP address and the identification number. A new tunnel is established between the target ENB and the AGW, and an old tunnel between the source ENB and the AGW is released. Both inter-location area (LA) and intra-LA handover scenarios are addressed.

### CROSS REFERENCE TO RELATED APPLICATIONS

This application claims the benefit of U.S. Provisional Application No. 60/779,739 filed Mar. 7, 2006, and U.S. Provisional Application No. 60/792,935 filed Apr. 18, 2006 which are incorporated by reference as if fully set forth. This application is related to U.S. patent application Ser. No. 11/626,538 filed Jan. 24, 2007.

### FIELD OF INVENTION

The present invention is related to a wireless communication system. More particularly, the present invention is related to a method and apparatus for supporting handoff and evolved Node B (ENB) relocation procedures in a single tunnel long term evolution (LTE)-based wireless communication system.

### BACKGROUND

FIG. 1 shows a conventional GPRS/third generation (3G) wireless communication system architecture 100 that shows various interfaces/protocols as well as user data transfer interfaces between various network entities. The wireless communication system 100 includes at least one serving GPRS support node (SGSN) 105 and at least one gateway GPRS support node (GGSN) 110. The wireless communication system 100 further comprises a universal terrestrial radio access network (UTRAN) 115 which includes one or more radio access networks (RANs), base station systems (BSSs) and radio network controllers (RNCs), (not shown). The system 100 also comprises a plurality of wireless transmit/receive units (WTRUs) 120, each including a terminal equipment (TE) 125 coupled to a mobile terminal (MT) 130. The mobility in the wireless communication system 100 is facilitated by anchoring an Internet Protocol (IP) session at the GGSN 110 and allowing for multi-level mobility by supporting mobility management (MM) protocols for IP and non-IP traffic/services provided by the SGSN 105.

FIG. 2A shows how dual tunnels are established in the conventional wireless communication system 100 of FIG. 1 to provide IP connectivity for user plane traffic. As shown in FIG. 2, a GPRS tunnelling protocol (GTP) user plane (GTP-U) tunnel 220 is established between a GGSN 205 and an SGSN 210, and a second user plane tunnel 225 is established between the SGSN 210 and a radio network controller (RNC) 215. Both tunnels are dedicated to the same user. The GTP tunnel 220 has a user plane and a control plane. The user tunnel 225 is an IP tunnel having a user plane and a RAN application part (RANAP) control plane used for control messaging.

When an intra-SGSN handoff is implemented, the SGSN 210 switches the tunnel from an old RNC to a new RNC. A combined hard handover and SRNS relocation procedure is used to move the RAN to a core network (CN) connection point at the RAN side from the source serving RNC (SRNC) to the target RNC, while performing a hard handover decided by the RAN. In the procedure, the Iu links are relocated. If the target RNC is connected to the same SGSN as the source SRNC, an intra-SGSN SRNS relocation procedure is performed. If the routing area is changed, this procedure is followed by an intra-SGSN routing area update procedure. The SGSN detects that it is an intra-SGSN routing area update by noticing that it also handles the old routing area. In this case, the SGSN has the necessary information about the WRTU and there is no need to inform the HLR about the new WTRU location.

If the target RNC is connected to a different SGSN than the source SRNC, an inter-SGSN SRNS relocation procedure is performed. This procedure is followed by an inter-SGSN routing area update procedure.

A routing area update (RAU) is used to minimize the paging traffic within a wireless communication system that is grouped into clusters. Each cluster includes a group of cells (Node-Bs). Each cluster is defined by a unique identifier, (i.e., routing area identifier (ID)). Those WTRUs in the wireless communication system that travel across boundaries of the clusters have to perform a registration process called a routing area update. In the RAU, the WTRU informs the core network regarding which area of the system it is operating in. If the WTRU receives a terminated call, the core network pages the WTRU in the last known routing area. This eliminates the need to send a paging message for the WTRU throughout the entire system, which in turn significantly reduces the amount of signalling across the system. Thus, more processing power is allocated to user traffic. The RAU may require the establishment of a new connection between a GGSN and a new RNC. New processes and message formats are needed for a single tunnel approach as compared to those existing in a two tunnel approach.

Similarly, FIG. 3 is the system architecture evolution (SAE) of a long term evolution (LTE)-based network that shows various interfaces/protocols as well as user data transfer interfaces between various network entities. The wireless communication system 300 includes an evolved packet core 305 comprising at least one mobility management entity (MME)/user plane entity (UPE) 310 and at least one inter-access system (AS) anchor 315, also called an access gateway (AGW). An evolved radio access network 320 includes at least one evolved Node B (ENB). The wireless communication system 300 further comprises a GPRS core 325 as described above with reference to FIG. 1, which includes at least one universal terrestrial radio access network (UTRAN) 330, and at least one GPRS enhanced data rates for global system for mobile communications (GSM) evolution (EDGE) radio access network (GERAN) 335. Mobility of WTRUs (not shown) in the wireless communication system 300 is facilitated by anchoring Internet Protocol (IP) sessions at the AGW 315 and allowing for multi-level mobility by supporting mobility management (MM) protocols for IP traffic/services provided by the AGW 315.

LTE based networks are all IP Networks (AIPNs). IP traffic generated from the network operator, such as instant messaging, and non third generation partnership project (3G) IP traffic, such as wireless local area network (WLAN) traffic, is anchored and routed through the AGW 315. IP traffic destined for a WTRU does not need to be terminated at the MME/UPE 310. Therefore, a method and system for single IP tunnel functionality is desirable to reduce the delay and processing power at the MME/UPE in LTE-based networks.

### SUMMARY

The present invention is related to establishing a single general packet radio service (GPRS) tunneling protocol (GTP) tunnel for user plane traffic between an access gateway (AGW) and an evolved Node B (ENB) in a long term evolution (LTE) based wireless communication network. ENB relocation is implemented in a wireless communication system including at least one WTRU, a source ENB, a target ENB, an old mobility management entity (MME)/user plane entity (UPE), a new MME/UPE and an AGW. An old GTP-U tunnel is established between the source ENB and the AGW. The source ENB sends a relocation required message to the old MME/UPE. The old MME/UPE sends a forward relocation request message to the new MME/UPE. The new MME/UPE sends a relocation request message to the target ENB which indicates a tunnel endpoint identity (TEID) of the AGW, an identification number of the WTRU and the packet data protocol (PDP) address of the WTRU. The new MME/UPE sends an update PDP context request message to the AGW which indicates the TEID of the target ENB. The AGW updates a binding of the target ENB TEID with the PDP address and the identification number of the WTRU. A new GTP-U tunnel is established between the target ENB and the AGW, and the old GTP-U tunnel is released. Both inter-location area (LA) and intra-LA handover scenarios are addressed.

### BRIEF DESCRIPTION OF THE DRAWINGS

A more detailed understanding of the invention may be had from the following description of a preferred embodiment, given by way of example and to be understood in conjunction with the accompanying drawings wherein:

FIG. 1 shows a conventional GPRS and 3G wireless communication system;

FIG. 2 shows the conventional establishment of dual tunnels;

FIG. 3 shows the system architecture evolution (SAE) of a long term evolution (LTE)-based wireless communication system;

FIG. 4 shows the establishment of a single user plane tunnel in accordance with the present invention;

FIG. 5 shows a prior art tunnel protocol stack;

FIG. 6 shows a single user plane tunnel protocol stack configured in accordance with the present invention;

FIG. 7 shows a single user plane tunnel establishment procedure, (LTE Attach), which is implemented in accordance with the present invention;

FIG. 8 shows a system configuration before implementing intra-location area (LA) ENB relocation and routing area update using a single tunnel approach in accordance with the present invention;

FIG. 9 shows the system of claim 8 after implementing intra-LA ENB relocation procedure and routing area update using a single tunnel approach in accordance with the present invention;

FIG. 10 shows a system configuration before implementing inter-LA EN relocation and routing area update using a single tunnel approach in accordance with the present invention;

FIG. 11 shows the system of FIG. 10 after implementing inter-LA ENB relocation procedure and routing area update using a single tunnel approach in accordance with the present invention;

FIG. 12 is a signaling diagram of ENB relocation procedure in accordance with an embodiment of the present invention;

FIG. 13 shows a system configuration before implementing an inter-LA single tunnel combined hard handover and ENB relocation and routing area update procedure in accordance with the present invention;

FIG. 14 shows the system of FIG. 13 after implementing the inter-LA single tunnel combined hard handover and ENB relocation and routing area update procedure in accordance with the present invention; and

FIG. 15 is a signaling diagram of a single tunnel combined hard handover and ENB relocation procedure in accordance with another embodiment of the present invention.

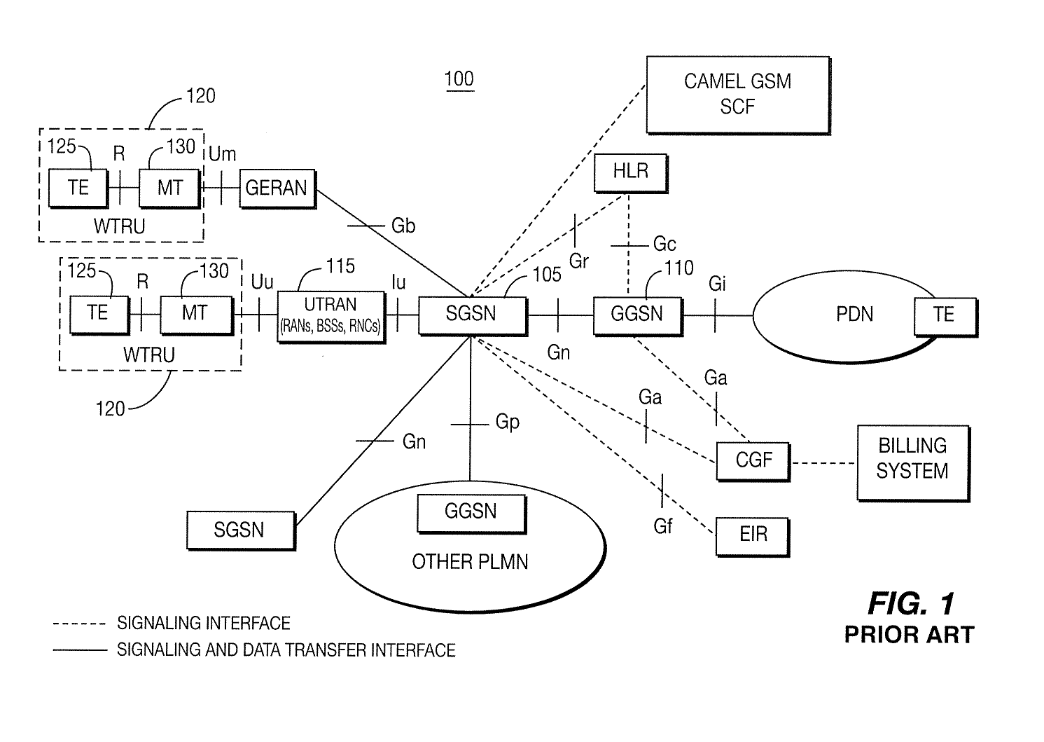

### DETAILED DESCRIPTION OF THE PREFERRED EMBODIMENTS

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

The features of the present invention may be incorporated into an integrated circuit (IC) or be configured in a circuit comprising a multitude of interconnecting components.

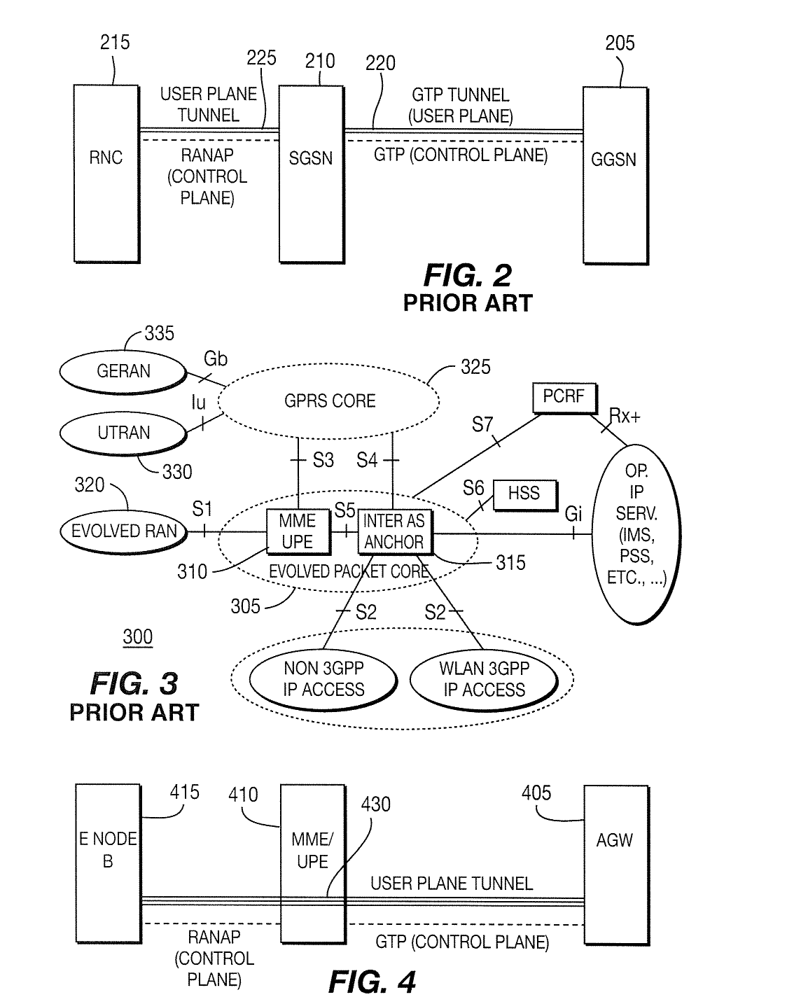

In accordance with the present invention, the mobility in LTE-based systems is facilitated by anchoring IP sessions at the AGW. FIG. 4 shows a single user-plane tunnel approach in accordance with the present invention. A single user plane tunnel 430 is used to reduce the delay and processing power required at the MME/UPE 410. In the GPRS two-tunnel approach shown in FIG. 2, the SGSN 210 terminates both the GTP tunnel 220 and a user plane tunnel 225 to the RNC 215, which means that the SGSN 210 decodes the packets traveling in both directions and translates them into the different protocol formats of the two tunnels 220 and 225. In the single tunnel approach shown in FIG. 4, the MME/UPE 410 is not involved in the user plane traffic. Thus, the user traffic passes through the MME/UPE 410 unchanged, (i.e., unaltered), in both directions. The MME/UPE 410 is not in the user plane processing. Only the ENB 415 and the AGW 405 are allowed to perform/act on the user plane traffic. The MME/UPE 410 only establishes a tunnel for control plane signaling between the AGW 405 and the ENB 415 via two separate interfaces/protocols, (RANAP-C and GTP-C). The MME/UPE 410 only manages control traffic, including MM, RAU, and the like, associated with the user and its IP based traffic. The MME/UPE 410 connects an ENB 415 and an AGW 405 using a GTP control plane to communicate with the AGW 405 and a RANAP control plane to communicate with the ENB 415. When a handoff occurs between ENBs, the MME/UPE 410 is responsible for providing the AGW 405 with the new ENB TEID information and the establishment of the single tunnel 430.

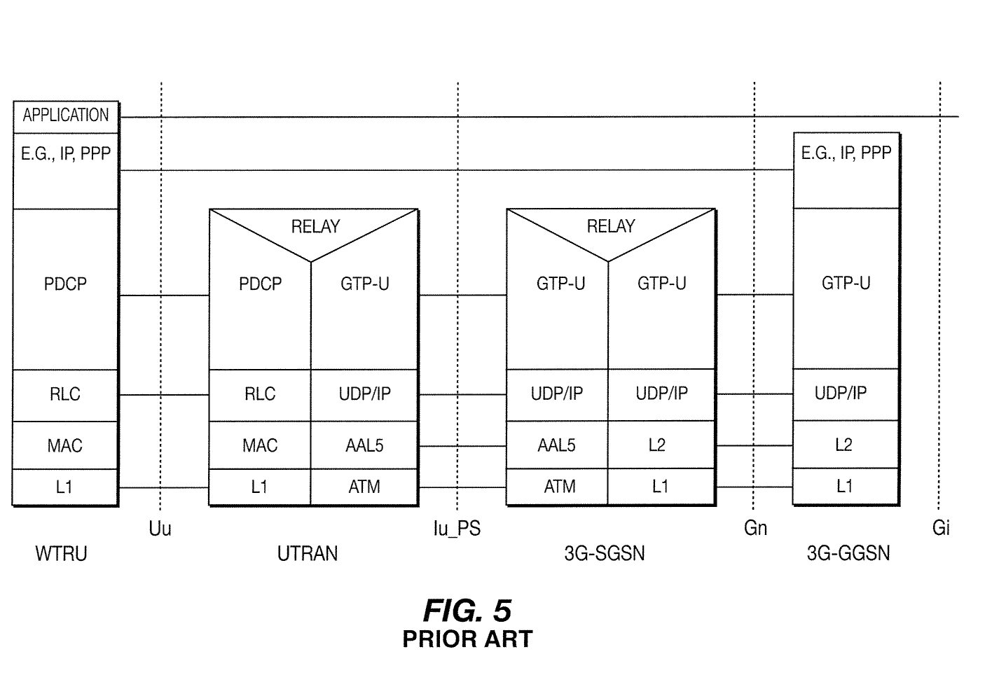

FIG. 5 shows a prior art tunnel protocol stack according to existing GPRS protocols. A GTP-U tunnel transfers, (i.e., tunnels), user data between a UTRAN (which includes RANs, BSSs and RNCs) and a 3G-SGSN, and between the 3G-SGSN and a 3G-GGSN.

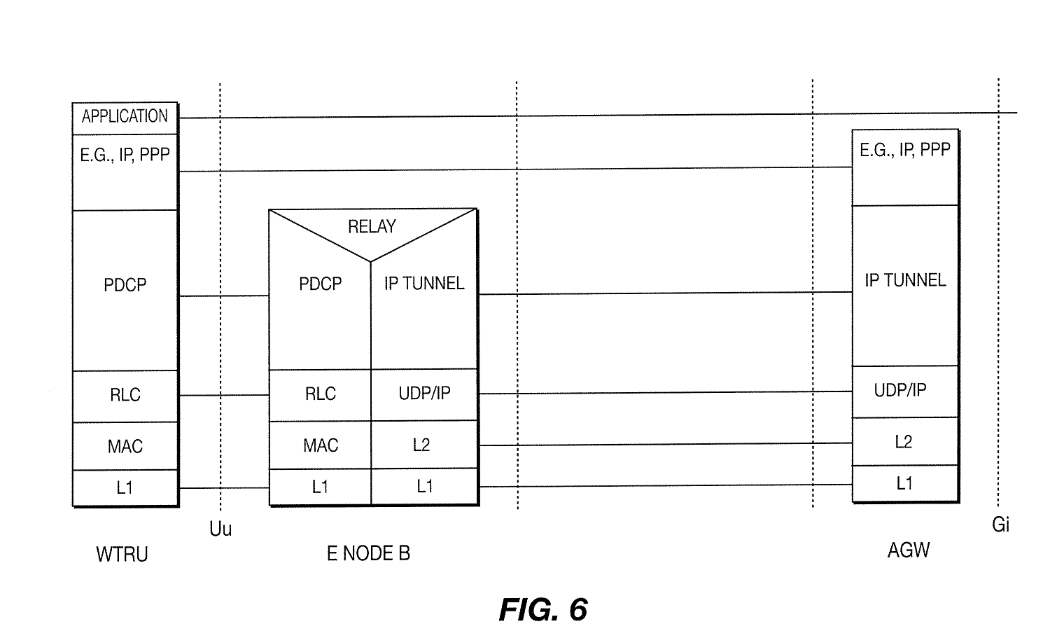

FIG. 6 shows a user plane single tunnel protocol stack in accordance with the present invention, in which the user plane tunnel from the ENB passes through the MME/UPE and terminates at the AGW. The IP Tunnel shown in both the ENB stack and the AGW stack can be GTP based or any generic IP-Tunnel. In a preferred embodiment, the GTP-U tunnel is used as an IP tunnel.

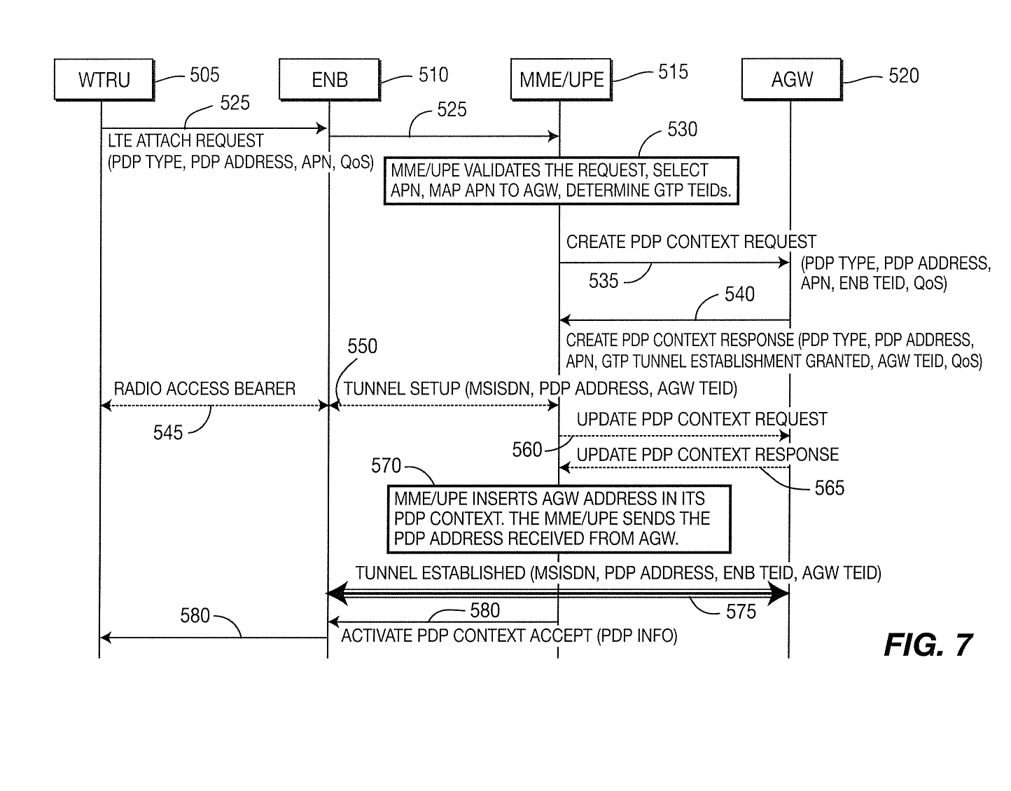

FIG. 7 is a signaling diagram of a process for single tunnel establishment in accordance with the present invention. The single tunnel functionality reduces the delay and processing power at the MME/UPE by reducing the need for protocol translation between the ENB and AGW interfaces, and by enabling a direct user plane tunnel between the ENB and the AGW within the packet switched (PS) domain. However, the single tunnel approach will not eliminate the need for the MME/UPE to manage control plane signalling for IP based traffic. The MME/UPE is still needed for control plane signalling, MM and call/session management.

In the case of a single tunnel, the MME/UPE should connect the ENB TEID and the AGW TEID for the user plane by informing each end point of the corresponding TEID of the other end point, (i.e., informing the AGW of the ENB TEID and informing the ENB of the AGW TEID). In the case of a handoff between ENBs, the MME/UPE is responsible for updating and providing the AGW with new ENB TEID information and the establishment of the single tunnel.

Still referring to FIG. 7, FIG. 7 is a signal flow diagram for a single tunnel establishment procedure (LTE Attach) which is implemented in a wireless communication system that includes a WTRU 505, an ENB 510, an MME/UPE 515, and an AGW 520. The WTRU 505 sends an LTE Attach request to the ENB 510 that includes PDP type, PDP address, APN, quality of service (QoS) data and the like, which is forwarded to the MME/UPE 515, (step 525). The MME/UPE 515 validates the LTE Attach request, selects an APN, and maps the APN to the AGW 520 (step 530). The MME/UPE 515 determines the GTP TEIDs, (step 530). The MME/UPE 515 creates a PDP context request that includes PDP Type, PDP Address, APN, ENB TEID, QoS, and the like, (step 535). The AGW 520 creates a PDP context response that includes PDP Type, PDP Address, APN, an indication of GTP tunnel establishment, AGW TEID, QoS, and the like (step 540). The WTRU 505 and the ENB 510 establish a radio access bearer (RAB), (step 545). In step 550, the MME/UPE 515 and the ENB 510 exchange tunnel setup signaling that includes a mobile station international subscriber directory number (MSISDN), a PDP address and an AGW TEID, and the MME/UPE 515 sends tunnel establishment information to the ENB 510 after receiving an indication of acceptance from the AGW to establish the tunnel. The MME/UPE 515 sends an update PDP context request to the AGW 520 (step 560) to establish the new tunnel by informing the AGW 520 of the ENB TEID associated with the request, and the AGW 520 sends an update PDP context response to the MME/UPE 515 (step 565) confirming/rejecting the establishment of the tunnel and the associated attributes, (ENB TEID, PDP type, PDP address, user ID, and the like). The MME/UPE 515 inserts the AGW address in its PDP context, sends the PDP address received from the AGW (step 570) and prepares for the response to be sent down to the WTRU 505. Thus, if necessary, the MME/UPE 515 updates the PDP context in the AGW 520 to reflect any changes in the QoS attributes resulting from the RAB establishment of step 545. Tunnel established signaling is exchanged between the ENB510 and the AGW 520 including the MSISDN, PDP address, ENB TEID and AGW TEID (step 575). The MME/UPE 515 sends an activate PDP context accept message to the WTRU 505 that indicates the PDP information, preferably including an IP address (step 580).

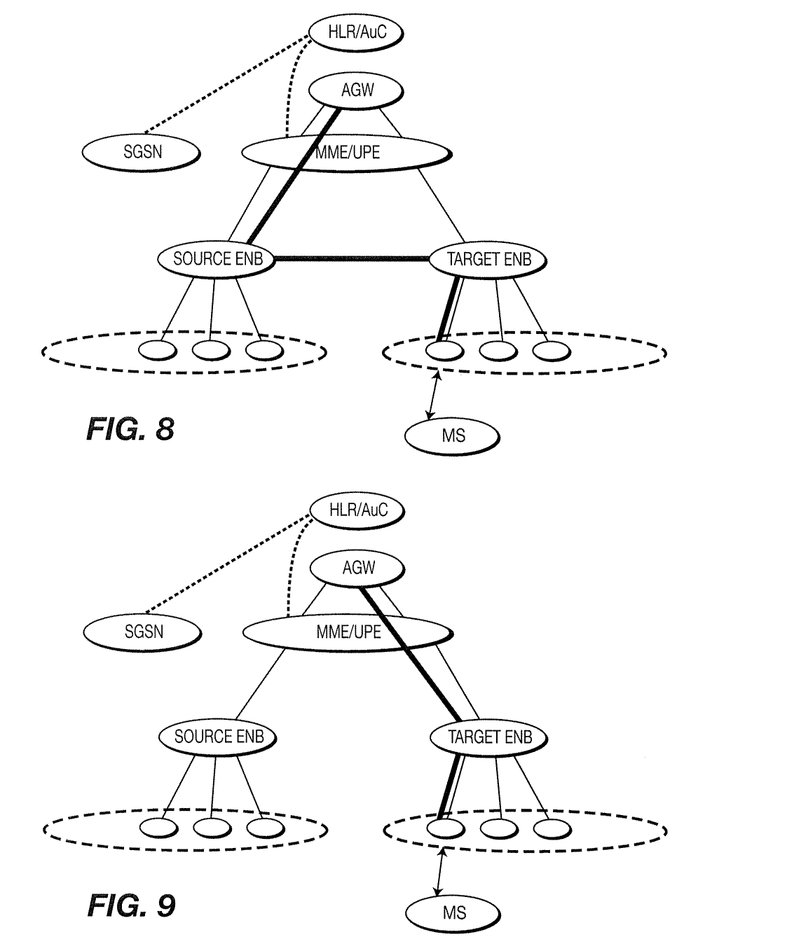

FIG. 8 shows a system configuration before implementing an intra location area (LA)/routing area (RA) handover procedure in accordance with the present invention.

FIG. 9 shows the system of FIG. 8 after implementing a handover procedure that uses ENB relocation and routing area update using a single tunnel approach in accordance with the present invention. The single tunnel between the AGW and the source ENB shown in FIG. 8 is relocated to a new single tunnel between the AGW and the target ENB during a handover procedure. It is noted that both tunnels pass through the same MME/UPE.

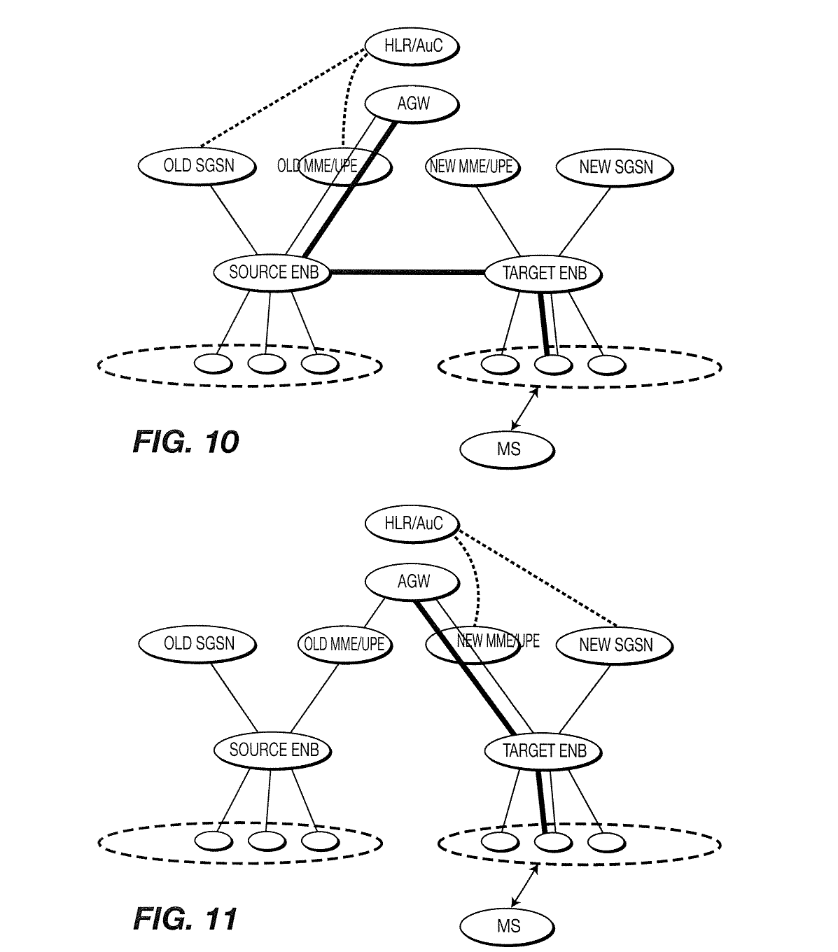

FIG. 10 shows a system configuration before implementing an inter LA/RA handover procedure in accordance with the present invention. It is noted that in this scenario the single tunnel is relocated from a first LA/RA including an old MME/UPE, to a second LA/RA including a new MME/UPE.

FIG. 11 shows the system of FIG. 10 after implementing a handover procedure that uses ENB relocation and routing area update using a single tunnel approach in accordance with the present invention. The single tunnel between the AGW and the source ENB that passes through the old MME/UPE shown in FIG. 10 is relocated to a new single tunnel between the AGW and the target ENB that passes through the new MME/UPE during a handover procedure.

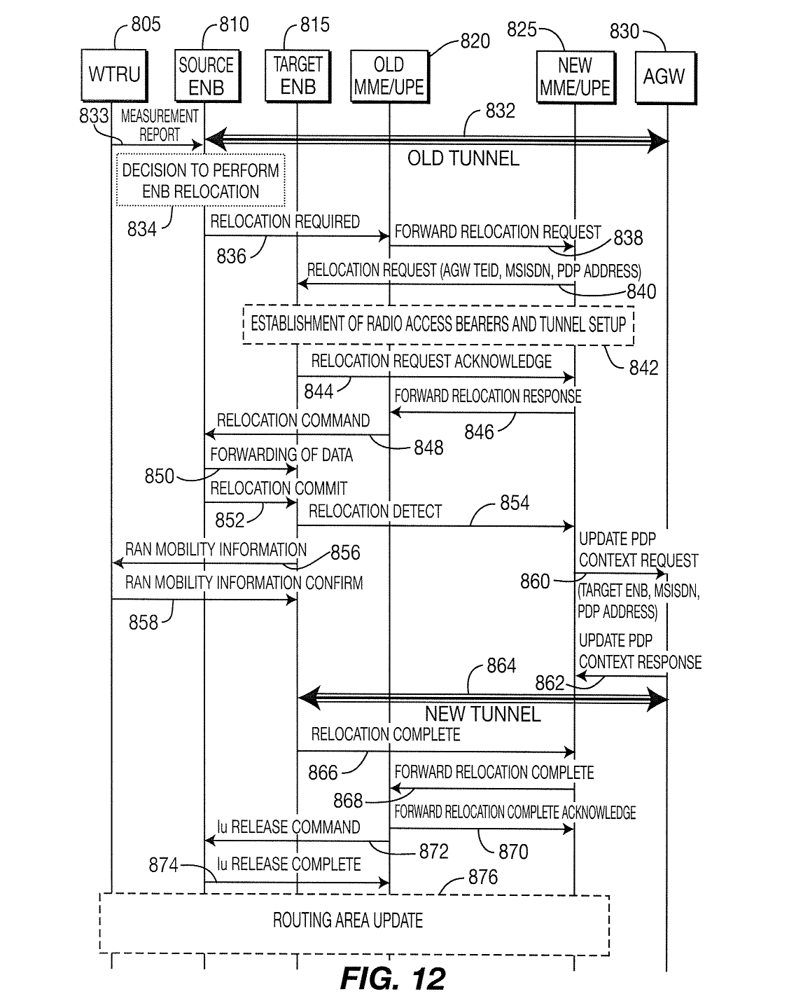

FIG. 12 is a signaling diagram of an ENB relocation procedure using a single tunnel approach implemented in a wireless communication system including a WTRU 805, a source ENB 810, a target ENB 815, an old MME/UPE 820, a new MME/UPE 825 and an AGW 830 in accordance with one embodiment of the present invention.

In step 832, an old tunnel is established between the source RNC 810 and the GGSN 830. The establishment of the old tunnel may occur, for example, in accordance with the LTE attach procedure described above with respect to FIG. 7.

In step 833, the WTRU may optionally report the quality of candidate cells to the source ENB 1110. The radio resource management (RRM) function of the source ENB 1110 may decide the WTRU 805 should be handed over to a target cell. The decision may be based on the measurement report 833 and various other performance and operating criteria as desired.

In step 834, the source ENB 810 decides to perform/initiate ENB relocation. If the measurement report 833 is proved by the WTRU 805, the decision may be based on the reported quality and load of the candidate cells. At this point, both uplink and downlink user and control data flows via at least one of the following tunnels: a radio bearer between the WTRU 805 and the source ENB 810, a single GTP user plane tunnel between the source ENB 810 and the AGW 830; a RANAP control plane tunnel(s) between the source ENB 810 and the old MME/UPE 820; and GTP control plane tunnel(s) between the old-MME/UPE 820 and the AGW 830.

In step 836, the source ENB 810 sends a relocation required message, (including relocation type, cause, source ID, target ID, source ENB to target ENB transparent container), to the old MME/UPE 820. The source ENB 810 sets the relocation type to “WTRU not involved”. The source ENB to target ENB transparent container includes the necessary information for relocation coordination, security functionality and radio resource control (RRC) protocol context information, (including WTRU capabilities).

The old MME/UPE 820 determines from the target ID if the ENB relocation is an intra-MME/UPE ENB relocation or an inter-MME/UPE ENB relocation. In the case of an inter-MME/UPE ENB relocation, the old MME/UPE 820 initiates the relocation resource allocation procedure by sending a forward relocation request message, (IMSI, TEID signaling, MM context, PDP context, target identification, RAN transparent container, RANAP cause) to the new MME/UPE 825 (step 838). For relocation to an area where intra domain connection of RAN nodes to multiple CN nodes is used, the old MME/UPE 820 may, (if it provides intra domain connection of RAN nodes to multiple CN nodes), have multiple target MME/UPEs for each relocation target in a pool area, in which case the old MME/UPE 820 will select one of them to become the new MME/UPE 825. The PDP context contains an AGW address for user plane and uplink TEID for data, (to this AGW address and uplink TEID, for data the old MME/UPE 820 and the new MME/UPE 825 send uplink packets). At the same time, a timer is started on the MM and PDP contexts in the old MME/UPE 820. The forward relocation request message of step 838 is applicable only in the case of inter-MME/UPE ENB relocation.

In step 840, the new MME/UPE 825 sends a relocation request message, (including a permanent non-access stratum (NAS) WTRU identity, cause, CN domain indicator, source RNC to target RNC transparent container, RABs to be setup),to the target RNC 815.

In accordance with the present invention, the relocation request message also indicates a the TEID of the AGW 830 and the association between both the MSISDN of the WTRU 805 and its PDP address with the TEID of the AGW 830

In step 842, RABs are established and a tunnel setup at the target RNC 815 is established in accordance with the present invention. Only the Iu bearers of the RABs are setup between the target ENB 815 and the new MME/UPE 825, since the existing RABs will be reallocated between the WTRU 805 and the target ENB 815 when the target ENB 815 begins handling traffic destined for the WTRU 805. For each requested RAB, the RAB's information elements may contain information such as RAB ID, RAB parameters, transport layer address and Iu transport association. The RAB ID information element contains the network layer service access point identifier (NSAPI) value, and the RAB parameters information element provides the quality of service (QoS) profile. The transport layer address is the MME/UPE address for user data, and the Iu transport association corresponds to the uplink TEID data.

After all necessary resources for accepted RABs including the Iu user plane are successfully allocated, the target ENB 815 sends a relocation request acknowledge message, (RABs setup, RABs failed to setup), to the new MME/UPE 825 (step 844). Each RAB to be setup is defined by a transport layer address, which is the address of the target ENB 815 for user data, and an Iu transport association, which corresponds to the downlink TEID for user data. For each RAB to be set up, the target ENB 815 may simultaneously receive downlink user packets both from the source ENB 810 and from the new MME/UPE 825.

When resources for the transmission of user data between the target ENB 815 and the new MME/UPE 825 have been allocated, and the new MME/UPE 825 is ready for relocation, a forward relocation response message, (cause, RANAP cause, and RAB setup information), is sent from the new MME/UPE 825 to the old MME/UPE 820 (step 846). The forward relocation response message indicates that the target ENB 815 is ready to receive from source ENB 810 the forwarded downlink PDUs, (i.e., the relocation resource allocation procedure is terminated successfully). The RANAP cause is information from the target ENB 815 to be forwarded to the source ENB 810. The RAB setup information, one information element for each RAB, contains the ENB TEID and the ENB IP address for data forwarded from the source ENB 810 to the target ENB 815. If the target ENB 815 or the new MME/UPE 825 failed to allocate resources, the RAB setup information element contains only NSAPI indicating that the source ENB 810 shall release the resources associated with the NSAPI. The forward relocation response message of step 846 is applicable only in case of inter-MME/UPE ENB relocation.

The old MME/UPE 820 continues ENB relocation by sending a relocation command message, (RABs to be released, and RABs subject to data forwarding), to the source ENB 810 (step 848). The old MME/UPE 820 determines the RABs to be subject for data forwarding based on QoS, and those RABs shall be contained in RABs subject to data forwarding. For each RAB subject to data forwarding, the information element shall contain an RAB ID, transport layer address, and Iu transport association. These are the same transport layer address and Iu transport association that the target ENB 815 had sent to the new MME/UPE 825 in the relocation request acknowledge message of step 844, and these are used for forwarding of downlink PDUs from the source ENB 810 to the target ENB 815. The source ENB 810 is now ready to forward downlink user data directly to the target ENB 815 over the Iu interface. This forwarding is performed for downlink user data only.

In step 850, the source ENB 810 may, according to the QoS profile, begin the forwarding of data to the target ENB 815 for the RABs to be subject for data forwarding. The data forwarding during relocation shall be carried out through the Iu interface, meaning that the data exchanged between the source ENB 810 and the target ENB 815 are duplicated in the source ENB 810 and routed at IP layer towards the target ENB 815. For each radio bearer which uses a lossless packet data convergence protocol (PDCP), the GTP-PDUs related to transmitted but not yet acknowledged PDCP-PDUs are duplicated and routed at IP layer towards the target ENB 815 together with their related downlink PDCP sequence numbers. The source ENB 810 continues transmitting duplicates of downlink data and receiving uplink data. Before the role of the serving ENB is taken over by the target ENB 815, and when downlink user plane data starts to arrive at the target ENB 815, the target ENB 815 may buffer or discard arriving downlink GTP-PDUs according to the related QoS profile.

It should be noted that the order of steps 850-876 of the ENB relocation procedure shown in FIG. 8 does not necessarily reflect the order of events and the steps 850-876 may be performed simultaneously or in a different order. For instance, the source ENB 810 may start data forwarding in step 850 and send a relocation commit message (step 852) almost simultaneously except in the delivery order required case where step 850 triggers step 852. The target ENB 815 may send a relocation detect message (step 854) and a RAN mobility information message (step 856) at the same time. Hence, the target ENB 815 may receive a RAN mobility information confirm message (step 858) while data forwarding (step 850) is still underway, and before the new MME/UPE 825 receives an update PDP context response message (step 862).

Before sending the relocation commit message at step 852 for the uplink and downlink data transfer in the source ENB 810, the source ENB 810 is suspended for RABs, which require delivery order. The source ENB 810 shall start the data-forwarding timer. When the source ENB 810 is ready, the source ENB 810 triggers the execution of relocation of ENB by sending a relocation commit message, (ENB contexts), to the target ENB 815 (step 852). The purpose of this procedure is to transfer ENB contexts from the source ENB 810 to the target ENB 815. ENB contexts are sent for each concerned RAB and contain the sequence numbers of the GTP-PDUs next to be transmitted in the uplink and downlink directions and the next PDCP sequence numbers that would have been used to send and receive data from the WTRU 805. For PDP context(s) using delivery order not required (QoS profile), the sequence numbers of the GTP-PDUs next to be transmitted are not used by the target ENB 815. PDCP sequence numbers are only sent by the source ENB 810 for radio bearers, which used lossless PDCP. The use of lossless PDCP is selected by the source ENB 810 when the radio bearer is set up or reconfigured.

If delivery order is required (QoS profile), consecutive GTP-PDU sequence numbering shall be maintained throughout the lifetime of the PDP context(s). Therefore, during the entire ENB relocation procedure for the PDP context(s) using delivery order required (QoS profile), the responsible GTP-U entities, (ENBs and AGWs), shall assign consecutive GTP-PDU sequence numbers to user packets belonging to the same PDP context for uplink and downlink, respectively.

In step 854, the target ENB 815 sends a relocation detect message to the new MME/UPE 825 when the relocation execution trigger is received. For ENB relocation type “WTRU not involved”, the relocation execution trigger is the reception of the relocation commit message at step 852. When the relocation detect message is sent at step 854, the target ENB 815 shall start serving ENB operation.

At step 856, the target ENB 815 sends a RAN mobility information message that contains WTRU information elements and CN information elements. The WTRU information elements include, among others, a new ENB identity and a subscriber radio network temporary identity (S-RNTI). The CN information elements contain, among others, location area identification and routing area identification. The procedure is coordinated in all Iu signaling connections existing for the WTRU 805.

The target ENB 815 establishes and/or restarts the RLC, and exchanges the PDCP sequence numbers, (PDCP sequence number (SNU), PDCP sequence number downlink (SND)), between the target ENB 815 and the WTRU 805. The PDCP SND is the PDCP sequence number for the next expected in-sequence downlink packet to be received in the WTRU 805 per radio bearer, which used lossless PDCP in the source RNC 810. The PDCP SND confirms all mobile-terminated packets successfully transferred before the ENB relocation. If the PDCP SND confirms reception of packets that were forwarded from the source ENB 810, the target ENB 815 shall discard these packets. The PDCP SNU is the PDCP sequence number for the next expected in-sequence uplink packet to be received in the ENB per radio bearer, which used lossless PDCP in the source ENB 810. The PDCP SNU confirms all WTRU originated packets successfully transferred before the ENB relocation. If PDCP SNU confirms reception of packets that were received in the source ENB 810, the WTRU 805 shall discard these packets.

Upon reception of the RAN mobility information message at step 856, the WTRU 805 may start sending uplink user data to the target ENB 815. When the WTRU 805 has reconfigured itself, it sends a RAN mobility information confirm message to the target ENB 815 at step 858. This indicates that the WTRU 805 is also ready to receive downlink data from the target ENB 815.

In step 860, the new MME/UPE 825 sends an update PDP context request message to the AGW 830 which indicates the TEID of the target ENB 815 in accordance with the present invention. In response, the AGW 830 updates the binding of the TEID of the target ENB 815 with the PDP address and the MSISDN of the WTRU 805. Thus, MME/UPE 825 sends the name of the new connection that data will be forwarded to by the AGW 830. Once this information is received, the AGW 830 updates the information pertaining to this tunnel, (i.e., new destination).

For all of the RABs, the target ENB 815 starts uplink reception of data and starts transmission of uplink GTP-PDUs towards the new MME/UPE 825, and the target ENB 815 starts processing the already buffered and the arriving downlink GTP-PDUs and starts downlink transmission towards the WTRU 805.

Upon receipt of the relocation detect message at step 854, the CN may switch the user plane from the source ENB 810 to the target ENB 815. If the ENB relocation is an inter-MME/UPE ENB relocation, the new MME/UPE 825 sends update PDP context request messages, (new MME/UPE address, MME/UPE TEID, QoS negotiated), to the AGW concerned. The MME/UPEs update their PDP context fields and return an update PDP context response (AGW TEID) at step 862. A new GTP user plane tunnel is then established between the target ENB 815 and the AGW 830 at step 864 in accordance with the present invention.

If the new MME/UPE 825 has already received the update PDP context response message from the AGW 830, the new MME/UPE 825 forwards the uplink user data to the AGW 830 over the new GTP user plane tunnel. Otherwise, the new MME/UPE 825 forwards the uplink user data to the IP address of the AGW 830 and TEID(s), which the new MME/UPE 825 had received earlier by the forward relocation request message at step 838.

When the target ENB 815 receives the RAN mobility information confirm message at step 858, (i.e., the ID of the target ENB 815 and an S-RNTI are successfully exchanged with the WTRU 805 by the radio protocols), the target ENB 815 initiates a relocation complete procedure by sending a relocation complete message to the new MME/UPE 825 at step 866.

The purpose of the relocation complete procedure is to indicate by the target ENB 815 the completion of the ENB relocation to the CN. If the user plane has not been switched at relocation detect and upon reception of relocation complete, the CN switches the user plane from the source ENB 810 to the target ENB 815. If the ENB relocation is an inter-MME/UPE ENB relocation, the new MME/UPE 825 signals to the old MME/UPE 820 the completion of the ENB relocation procedure by sending a forward relocation complete message at step 868.

Upon receiving the forward relocation complete message, or if an inter-MME/UPE ENB relocation is taking place, the old MME/UPE 820 sends a forward relocation complete acknowledge message to the new MME/UPE at step 870, and the old MME/UPE 820 sends an Iu release command message to the source ENB 810 at step 872. When the ENB data-forwarding timer expires, the source ENB 810 responds with an Iu release complete message at step 874.

After the WTRU 805 has finished the RNTI reallocation procedure and, if the new routing area identification is different from the old one, the WTRU 805 initiates a routing area update procedure at step 876.

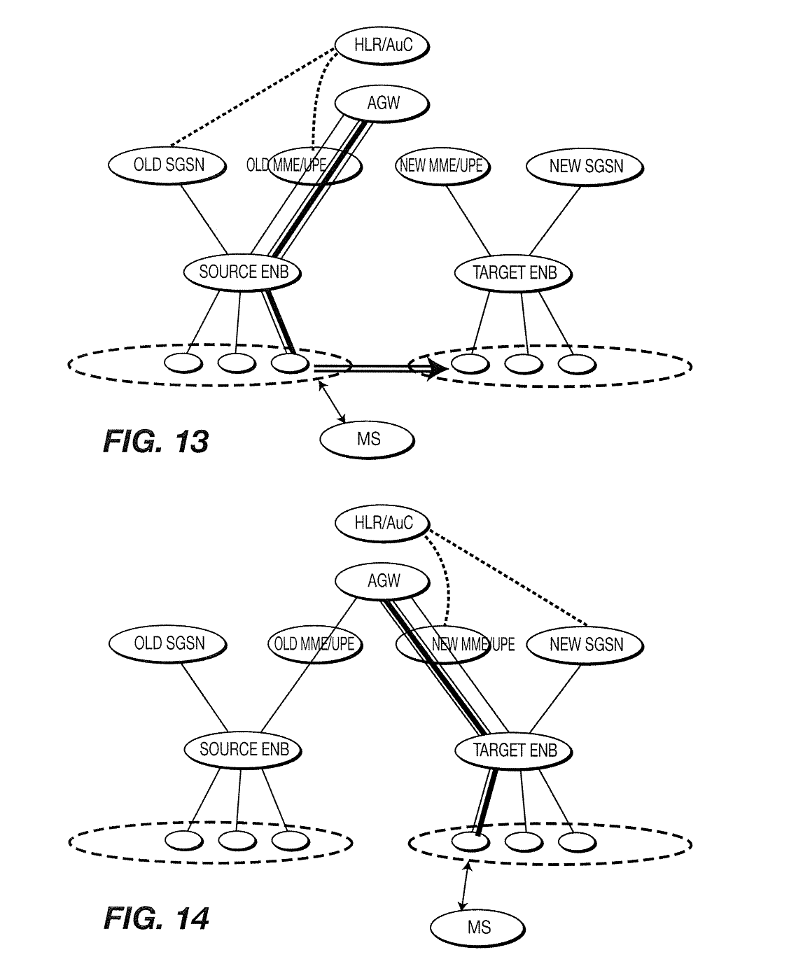

FIG. 13 shows a system configuration before implementing a single tunnel combined inter-LA/RA hard handover and ENB relocation and routing area update procedure in accordance with the present invention.

FIG. 14 shows the system of FIG. 13 after implementing a single tunnel combined inter-LA/RA hard handover and ENB relocation and routing area update procedure in accordance with the present invention.

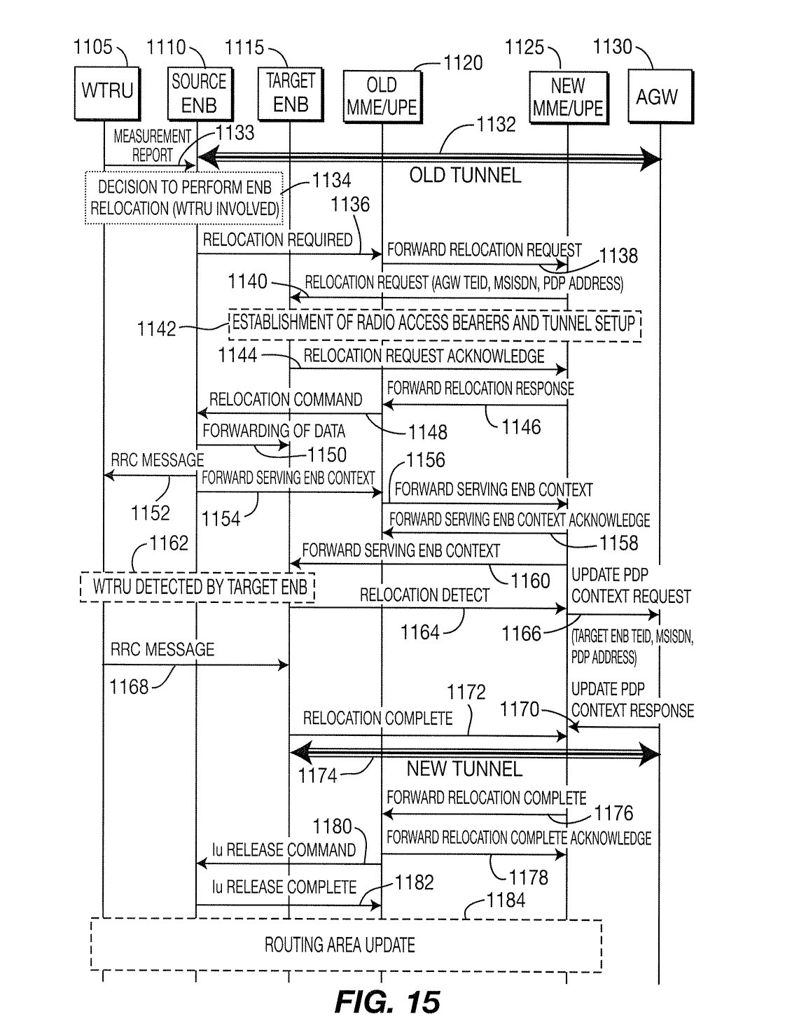

FIG. 15 is a signaling diagram of a single tunnel combined inter-LA/RA hard handover and ENB relocation procedure implemented in a wireless communication system including a WTRU 1105, a source ENB 1110, a target ENB 1115, an old MME/UPE 1120, a new MME/UPE 1125 and an AGW 1130 in accordance with another embodiment of the present invention. The procedure of FIG. 15 is applicable to both intra-MME/UPE ENB relocation and inter-MME/UPE ENB relocation.

In step 1132, an old tunnel is established between the source ENB 1110 and the AGW 1130. This old tunnel may be established, for example, by way of the LTE attach procedure described above with reference to FIG. 7.

In step 1133, the WTRU may optionally report the quality of candidate cells to the source ENB 1110. The radio resource management (RRM) function of the source ENB 1110 may decide the WTRU 1105 should be handed over to a target cell. The decision may be based on the measurement report 1133 and various other performance and operating criteria as desired.

In step 1134, the source ENB 1110 decides to perform/initiate a combined hard handover and ENB relocation. If the measurement report 1133 is proved by the WTRU 1105, the decision may be based on the reported quality and load of the candidate cells. At this point, both uplink and downlink user and control data flows via at least one of the following tunnels: a radio bearer between the WTRU 1105 and the source ENB 1110; GTP user plane tunnel between the source ENB and the AGW; RANAP control plane tunnel(s) between the source ENB 1110 and the old MME/UPE 1120; and GTP control plane tunnel(s) between the old MME/UPE 1120 and the AGW 1130.

In step 1136, the source ENB 1110 sends a relocation required message, (including relocation type, cause, source ID, target ID, source ENB to target ENB transparent container), to the old MME/UPE 1120. The source ENB 1110 sets the relocation type to “WTRU involved”. The source ENB to target ENB transparent container includes the necessary information for relocation coordination, security functionality and RRC protocol context information, (including WTRU capabilities).

The old MME/UPE 1120 determines from the target ID if the ENB relocation is an intra-MME/UPE ENB relocation or an inter-MME/UPE ENB relocation. In the case of an inter-MME/UPE ENB relocation, the old MME/UPE 1120 initiates the relocation resource allocation procedure by sending a forward relocation request message, (IMSI, TEID signaling, MM context, PDP context, target identification, RAN transparent container, RANAP cause) to the new MME/UPE 1125 (step 1138). For relocation to an area where intra domain connection of RAN nodes to multiple CN nodes is used, the old MME/UPE 1120 may, (if it provides intra domain connection of RAN nodes to multiple CN nodes), have multiple target MME/UPEs for each relocation target in a pool area, in which case the old MME/UPE 1120 will select one of them to become the new MME/UPE 1125. The PDP context contains an AGW address for user plane and uplink TEID for data, (to this AGW address and uplink TEID, for data the old MME[UPE 1120 and the new MME/UPE 1125 send uplink packets). At the same time, a timer is started on the MM and PDP contexts in the old MME/UPE 1120. The forward relocation request message of step 1138 is applicable only in the case of inter-MME/UPE ENB relocation.

In step 1140, the new MME/UPE 1125 sends a relocation request message, (including a permanent non-access stratum (NAS) WTRU identity, cause, CN domain indicator, source ENB to target ENB transparent container, RABs to be setup),to the target ENB 1115. For relocation to an area where intra domain connection of RAN nodes to multiple CN Nodes is used, the old MME/UPE 1120 may, if it provides intra domain connection of RAN nodes to multiple CN nodes, have multiple target MME/UPEs for each relocation target in a pool area, in which case the old MME/UPE 1120 will select one of them to become the new MME/UPE 1125. PDP context contains an AGW address for user plane and uplink TEID for data, (to this AGW address and uplink TEID for data). The old MME/UPE 1120 and the new MME/UPE 1125 send uplink packets. At the same time, a timer is started on the MM and PDP contexts in the old MME/UPE 1120. The forward relocation request message is applicable only for inter-MME/UPE ENB relocation.

In accordance with the present invention, the relocation request message also indicates the TEID of the AGW 1130 and the association between both the MSISDN of the WTRU 1105 and its PDP address with the TEID of the AGW 1130.

In step 1142, RABs are established and a tunnel setup at the target ENB 1115 is established in accordance with the present invention. Only the Iu bearers of the RABs are setup between the target ENB 1115 and the new MME/UPE 1125, since the existing RABs will be reallocated between the WTRU 1105 and the target ENB 1115. For each requested RAB, the RAB's information elements may contain information such as RAB ID, RAB parameters, transport layer address and Iu transport association. The RAB ID information element contains the network layer service access point identifier (NSAPI) value, and the RAB parameters information element provides the quality of service (QoS) profile. The transport layer address is the MME/UPE address for user data, and the Iu transport association corresponds to the uplink TEID data.

After all necessary resources for accepted RABs including the Iu user plane are successfully allocated, the target ENB 1115 sends a relocation request acknowledge message, (RABs setup, RABs failed to setup), to the new MME/UPE 1125 (step 1144). Each RAB to be setup is defined by a transport layer address, which is the address of the target ENB 1115 for user data, and an Iu transport association, which corresponds to the downlink TEID for user data. For each RAB to be set up, the target ENB 1115 may simultaneously receive downlink user packets both from the source ENB 1110 and from the new MME/UPE 1125.

When resources for the transmission of user data between the target ENB 1115 and the new MME/UPE 1125 have been allocated, and the new MME/UPE 1125 is ready for relocation, a forward relocation response message, (cause, RAN transparent container, RANAP cause, target-ENB information), is sent from the new MME/UPE 1125 to the old MME/UPE 1120, (step 1146). The forward relocation response message indicates that the target ENB 1115 is ready to receive from the source ENB 1110 the forwarded downlink PDUs, (i.e., the relocation resource allocation procedure is terminated successfully). The RAN transparent container and the RANAP cause are information from the target ENB 1115 to be forwarded to the source ENB 1110. The target ENB information, one information element for each RAB to be set up, contains the ENB TEID and the ENB IP address for data forwarded from the source ENB 1110 to the target ENB 1115. The forward relocation response message of step 1146 is applicable only for inter-MME/UPE ENB relocation.

The old MME/UPE 1120 continues the relocation of ENB by sending a relocation command message, (RABs to be released, and RABs subject to data forwarding), to the source ENB 1110 (step 1148). The old MME/UPE 1120 determines the RABs to be subject for data forwarding based on QoS, and those RABs shall be contained in RABs subject to data forwarding. For each RAB subject to data forwarding, the information element shall contain an RAB ID, transport layer address, and Iu transport association. These are the same transport layer address and Iu transport association that the target ENB 1115 had sent to the new MME/UPE 1125 in the relocation request acknowledge message of step 1144, and these are used for forwarding of downlink PDUs from the source ENB 1110 to the target ENB 1115. The source ENB 1110 is now ready to forward downlink user data directly to the target ENB 1115 over the Iu interface. This forwarding is performed for downlink user data only.

In step 1150, the source ENB 1110 may, according to the QoS profile, begin the forwarding of data to the target ENB 1115 for the RABs to be subject for data forwarding. The data forwarding at ENB relocation shall be carried out through the Iu interface, meaning that the data (GTP-PDUs) exchanged between the source ENB 1110 and the target ENB 1115 are duplicated in the source ENB 1110 and routed at the IP layer towards the target ENB 1115. For each radio bearer which uses a lossless packet data convergence protocol (PDCP), the GTP-PDUs related to transmitted but not yet acknowledged PDCP-PDUs are duplicated and routed at IP layer towards the target ENB 1115 together with their related downlink PDCP sequence numbers. The source ENB 1110 continues transmitting duplicates of downlink data and receiving uplink data. Before the role of the serving ENB is not yet taken over by the target ENB 1115, and when downlink user plane data starts to arrive at the target ENB 1115, the target ENB 1115 may buffer or discard arriving downlink GTP-PDUs according to the related QoS profile.

It should be noted that the order of steps 1150-1184 of the single tunnel combined hard handover and ENB relocation procedure shown in FIG. 15 does not necessarily reflect the order of events and may be performed simultaneously or in a different order. For instance, the source ENB 1110 may start data forwarding in step 1150, send an RRC message to the WTRU 1105 (step 1152) and forward serving ENB context message to the old MME/UPE (step 1154) almost simultaneously.

Before sending the RRC message in step 1152, the uplink and downlink data transfer is suspended in the source ENB 1110 for RABs, which require delivery order. The RRC message is, for example, physical channel reconfiguration for RNS to RNS relocation, or intersystem to UTRAN handover for BSS to RNS relocation, or handover from UTRAN command for BSS relocation, or handover command for BSS to BSS relocation. When the source ENB 1110 is ready, the source ENB 1110 triggers the execution of ENB relocation by sending to the WTRU 1105 the RRC message provided in the target ENB 1115 to source ENB 1110 transparent container, e.g., a physical channel reconfiguration (WTRU information elements, CN information elements) message (step 1152). WTRU information elements include, among others, a new serving ENB identity and S-RNTI. CN information elements contain, among others, location area identification and routing area identification.

The source ENB 1110 continues the execution of ENB relocation by sending a forward serving ENB context (RAB contexts) message to the target ENB 1115 via the old MME/UPE 1120 and the new MME/UPE 1125 (steps 1154, 1156 and 1160). The forward serving ENB context message is acknowledged by a forward serving ENB context acknowledge message, from new MME/UPE 1125 to the old MME/UPE 1120 (step 1158). The purpose of this procedure is to transfer serving ENB contexts from the source ENB 1110 to the target ENB 1115, and to move the serving ENB role from the source ENB 1110 to the target ENB 1115. Serving ENB contexts are sent for each concerned RAB and contain the sequence numbers of the GTP PDUs next to be transmitted in the uplink and downlink directions and the next PDCP sequence numbers that would have been used to send and receive data from the WTRU 1105. PDCP sequence numbers are only sent by the source ENB 1110 for the radio bearers which used lossless PDCP. The use of lossless PDCP is selected by the source ENB 1110 when the radio bearer is set up or reconfigured. For PDP context(s) using delivery order not required (QoS profile), the sequence numbers of the GTP-PDUs next to be transmitted are not used by the target ENB 1115.

If delivery order is required (QoS profile), consecutive GTP-PDU sequence numbering shall be maintained throughout the lifetime of the PDP context(s). Therefore, during the entire serving ENB relocation procedure for the PDP context(s) using delivery order required (QoS profile), the responsible GTP-U entities (the ENBs 1110 and 1115, and the AGW 1130) shall assign consecutive GTP-PDU sequence numbers to user packets belonging to the same PDP context uplink and downlink, respectively.

The target ENB 1115 establishes and/or restarts the RLC and exchanges the PDCP sequence numbers, (PDCP-SNU, PDCP-SND), between the target ENB 1115 and the WTRU 1105. PDCP-SND is the PDCP sequence number for the next expected in-sequence downlink packet to be received by the WTRU 1105 per radio bearer, which used lossless PDCP in the source ENB 1110. PDCP-SND confirms all mobile terminated packets successfully transferred before the serving ENB relocation. If PDCP-SND confirms reception of packets that were forwarded from the source ENB 1110, then the target ENB 1115 shall discard these packets. PDCP-SNU is the PDCP sequence number for the next expected in-sequence uplink packet to be received in the ENB per radio bearer, which used lossless PDCP in the source ENB 1110. PDCP-SNU confirms all mobile originated packets successfully transferred before the serving ENB relocation. If PDCP-SNU confirms reception of packets that were received in the source ENB 1110, the WTRU 1105 discards these packets.

The target ENB 1115 sends a relocation detect message to the new MME/UPE 1164 when the relocation execution trigger is received (step 1164). For ENB relocation type “WTRU involved”, the relocation execution trigger may be received from the Uu interface; (i.e., when the target ENB 1115 detects the WTRU 1105 on the lower layers (step 1162)). When the relocation detect message is sent at step 1164, the target ENB 1115 starts serving ENB operation.

In step 1166, the new MME/UPE 1125 sends an update PDP context request message to the AGW 1130 which indicates a single tunnel configuration and the TEID of the target ENB 1115 in accordance with the present invention. In response, the AGW 1130 updates the binding of the TEID of the target ENB 1115 with the PDP address and the MSISDN of the WTRU 1105.

For all of the RABs, the target ENB 1115 starts uplink reception of data and start transmission of uplink GTP-PDUs towards the new MME/UPE 1125, and the target ENB 1115 starts processing the already buffered and the arriving downlink GTP-PDUs and starts downlink transmission towards the WTRU 1105.

Upon receipt of the relocation detect message at step 1164, the CN may switch the user plane from the source ENB 1110 to the target ENB 1115. If the serving ENB relocation is an inter-MME/UPE ENB relocation, the new MME/UPE 1125 sends update PDP context request messages, (new MME/UPE address, MME/UPE TEID, QoS negotiated), to the AGW concerned. The AGW updates its PDP context fields and return an update PDP context response (AGW TEID) at step 1170. A new GTP user plane tunnel is the established between the target ENB 1115 and the AGW 1130 at step 1174 in accordance with the present invention.

If the new MME/UPE 1125 has already received the update PDP context response message from the AGW 1130, the new MME/UPE 1125 forwards the uplink user data to the AGW 1130 over the new GTP user plane tunnel. Otherwise, the new MME/UPE 1125 forwards the uplink user data to the IP address of the AGW 1130 and TEID(s), which the new MME/UPE 1125 had received earlier by the forward relocation request message at step 1138.

When the WTRU 1105 has reconfigured itself, it sends an RRC message, (e.g., a physical channel reconfiguration complete message), to the target ENB 1115 (step 1168). If a forward serving ENB context message with the sequence numbers is received at step 1160, the exchange of packets with the WTRU 1105 may start. If this message is not yet received, the target ENB 1115 may start the packet transfer for all RABs, which do not require maintaining the delivery order.

When the target ENB 1115 receives the RRC message at step 1168, the target ENB 1115 initiates a relocation complete procedure by sending a relocation complete message to the new MME/UPE 1125 at step 1172. The purpose of the relocation complete procedure is to indicate by the target ENB 1115 the completion of the serving ENB relocation to the CN. If the user plane has not been switched at relocation detect and upon reception of relocation complete, the CN switches the user plane from the source ENB 1110 to the target ENB 1115. If the ENB relocation is an inter-MME/UPE ENB relocation, the new MME/UPE 1125 signals to the old MME/UPE 1120 the completion of the serving ENB relocation procedure by sending a forward relocation complete message at step 1176.

Upon receiving the forward relocation complete message, or if an inter-MME/UPE serving ENB relocation is taking place, the old MME/UPE 1120 sends a forward relocation complete acknowledge message to the new MME/UPE at step 1178, and the old MME/UPE 1120 sends an Iu release command message to the source ENB 1110 at step 1180. When the ENB data-forwarding timer expires, the source ENB 1110 responds with an Iu release complete message at step 1182.

After the WTRU 1105 has finished the reconfiguration procedure and if the new routing area identification is different from the old one, the WTRU 1105 initiates a routing area update procedure at step 1184.

Although the features and elements of the present invention are described in the preferred embodiments in particular combinations, each feature or element can be used alone without the other features and elements of the preferred embodiments or in various combinations with or without other features and elements of the present invention. The methods or flow charts provided in the present invention may be implemented in a computer program, software, or firmware tangibly embodied in a computer-readable storage medium for execution by a general purpose computer or a processor. Examples of computer-readable storage medium includes a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. An evolved Node B (ENB) relocation method implemented in a wireless communication system including at least one wireless transmit/receive unit (WTRU), a source ENB, a target ENB, a first mobility management entity/user plane entity (MME/UPE), a second MME/UPE, and an access gateway (AGW), wherein a first GPRS tunnelling protocol (GTP) user plane (GTP-U) tunnel is established between the source ENB and the AGW, the method comprising:
(a) the source ENB sending a relocation required message to the first MME/UPE;
(b) the first MME/UPE sending a relocation request message to the second MME/UPE;
(c) the second MME/UPE sending a relocation request message to the target ENB which indicates a tunnel endpoint identity (TEID) of the AGW, an identification number of the WTRU and the packet data protocol (PDP) address of the WTRU;
(d) establishing a second GTP-U tunnel between the target ENB and the AGW; and
(e) releasing the first GTP-U tunnel.

2. The method of claim 1 further comprising:
(f) the second MME/UPE sending an update PDP context request message to the AGW which indicates a single tunnel operation and the TEID of the target ENB.

3. The method of claim 2 further comprising:
(g) the AGW updating a binding of the target ENB TEID with the PDP address of the WTRU and the identification number of the WTRU prior to executing step (d).

4. A wireless communication system for implementing an evolved Node B (ENB) relocation procedure, the system comprising:
(a) at least one wireless transmit/receive unit (WTRU);
(b) an access gateway (AGW);
(c) a first mobility management entity/user plane entity (MME/UPE);
(d) a source ENB associated with the first MME/UPE and configured to send a relocation required message to the first MME/UPE;
(e) a second MME/UPE configured to send a relocation request message to a target ENB in response to receiving a relocation request message sent by the first MME/UPE, the relocation request message indicating a tunnel endpoint identity (TEID) of the AGW, an identification number of the WTRU and the packet data protocol (PDP) address of the WTRU; and
(f) a target ENB associated with the second MME/UPE;
wherein a first general packet radio service (GPRS) tunnelling protocol (GTP) user plane (GTP-U) tunnel that is established between the source ENB and the AGW is released, and a second GTP-U tunnel is established between the target ENB and the AGW when the ENB relocation procedure is implemented.

5. The system of claim 4, wherein the second MME/UPE sends an update PDP context request message to the AGW which indicates the TEID of the target ENB.

6. The system of claim 5, wherein the AGW updates a binding of the target ENB TEID with the PDP address of the WTRU and the identification number of the WTRU prior to establishing the second GTP-U tunnel.

7. A wireless communication system for implementing a single tunnel combined hard handover and evolved Node B (ENB) relocation procedure, the system comprising:
(a) at least one wireless transmit/receive unit (WTRU);
(b) an access gateway (AGW);
(c) a first mobility management entity/user plane entity (MME/UPE);
(d) a target ENB associated with the first MME/UPE;
(e) a second MME/UPE configured to send a relocation request message to the target ENB in response to receiving a relocation request message sent by the first MME/UPE, the relocation request message indicating a tunnel endpoint identity (TEID) of the AGW, an identification number of the WTRU and the packet data protocol (PDP) address of the WTRU; and
(f) a source ENB configured to send a radio resource control (RRC) message to the WTRU, and to send a serving ENB context message to the target ENB via the first MME/UPE and the second MME/UPE;
wherein a first GPRS tunnelling protocol (GTP) user plane (GTP-U) tunnel that is established between the source ENB and the AGW is released, and a second GTP-U tunnel is established between the target ENB and the AGW when the combined hard handover and ENB relocation procedure is implemented.

8. The system of claim 7, wherein the second MME/UPE sends an update PDP context request message to the AGW which indicates the TEID of the target ENB.

9. The system of claim 8, wherein the AGW updates a binding of the target ENB TEID with the PDP address of the WTRU and the identification number of the WTRU prior to establishing the second GTP-U tunnel.

10. A combined hard handover and evolved Node B (ENB) relocation method implemented in a wireless communication system including at least one wireless transmit/receive unit (WTRU), a source ENB, a target ENB, a first mobile management entity/user plane entity (MME/UPE), a second MME/UPE, and an access gateway (AGW), wherein a first GPRS tunnelling protocol (GTP) user plane (GTP-U) tunnel is established between the source ENB and the AGW, the method comprising:
(a) the first MME/UPE sending a relocation request message to the second MME/UPE;
(b) the second MME/UPE sending a relocation request message to the target ENB which indicates a tunnel endpoint identity (TEID) of the AGW, an identification number of the WTRU and the packet data protocol (PDP) address of the WTRU;
(c) the source ENB sending a radio resource control (RRC) message to the WTRU;
(d) the source ENB sending a serving ENB context message to the target ENB via the first MME/UPE and the second MME/UPE;
(e) establishing a second GTP-U tunnel between the target ENB and the AGW; and
(f) releasing the first GTP-U tunnel.

11. The method of claim 10 further comprising:
(g) the second MME/UPE sending an update PDP context request message to the AGW which indicates a single tunnel operation and the TEID of the target ENB.

12. The method of claim 11 further comprising:
(h) the AGW updating a binding of the target ENB TEID with the PDP address of the WTRU and the identification number of the WTRU prior to executing step (e).

13. A method of establishing a general packet radio service (GPRS) tunnelling protocol (GTP) user plane (GTP-U) tunnel between an evolved Node B (ENB) and an access gateway (AGW) in a long term evolution (LTE) wireless communication network, the method comprising:
(a) transmitting from the WTRU an LTE attach request to the ENB;
(b) notifying the AGW of an ENB tunnel endpoint identification (TEID);
(c) notifying the ENB of an AGW TEID; and
(d) establishing a GTP-U tunnel between the ENB and the AGW.

14. The method of claim 13, wherein a mobility management entity/user plane entity (MME/UPE) manages control plane signalling between the ENB and the AGW.

15. The method of claim 13, wherein the AGW is notified of the ENB TEID by way of a create packet data protocol (PDP) context request message.

16. The method of claim 13, wherein the ENB is notified of the AGW TEID by way of a create PDP context response message.

17. A wireless communication system for transmitting user plane data to a wireless transmit/receive unit (WTRU) by way of a single general packet radio service (GPRS) tunneling protocol (GTP) user plane (GTP-U) tunnel, the system comprising:
(a) a WTRU configured to send an LTE attach request message;
(b) an evolved Node B (ENB) configured to forward an ENB tunnel endpoint identification (TEID) to an access gateway;
(c) an access gateway (AGW) configured to forward an AGW TEID to the ENB in response to receiving the ENB TEID;
(d) wherein a single GTP-U tunnel is established using the ENB TEID and the AGW TEID between the ENB and the AGW.

18. The system of claim 17, further comprising a mobility management entity/user plane entity (MME/UPE) configured to manage control plane signalling between the ENB and the AGW.

19. The system of claim 17, wherein the ENB TEID is forwarded to the AGW by way of a create packet data protocol (PDP) context request message.

20. The system of claim 17, wherein the AGW TEID is forwarded to the ENB by way of a create PDP context response message.
